(19) United States
(12) Patent Application Publication
(10) Pub. No.: US 2005/0101311 A1
(43) Pub. Date: May 12, 2005

(54) Data driven engine and system for wireless communications

(76) Inventors: Vernon Weitzman, Los Gatos, CA (US); Stephen R. Daly, Cupertino, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/966,609

(22) Filed: Oct. 14, 2004

Related U.S. Application Data
(60) Provisional application No. 60/512,009, filed on Oct. 15, 2003.

(51) Int. Cl. H04M 3/00

(52) U.S. Cl. 455/419

(57) ABSTRACT

A data driven engine system for wireless communication is provided to facilitate efficient running of applications on a remote wireless user device communicating with a server. The data driven engine in the only component permanently loaded on the user device and accesses Personality agent files from the server as selected by the user. The user is able to establish a home page with easily selectable Personality agent component files for performing common operations. The system minimizes memory usage on the user device while permitting high efficiency operation.

The following claims priority from a provisional patent application 60/512,009, filed 15 Oct. 2003 to the same inventors.

### TECHNICAL FIELD

The present invention relates generally to user interface and communications systems, particularly for use in electronic and wireless handheld device use.

### BACKGROUND ART

The present invention relates generally to the performance of activities on a handheld or other limited bandwidth communication device. Handhelds [(such as many popular wireless PDAs (personal digital assistants)] operate with a keyboard, screen, memory and communications bandwidth that is much more restricted than desktop computers with hardwired network connections.

There has been a significant amount of effort made in the establishment of protocols that enable the handhelds to do applications that would be found on a desktop by working hand in hand with a server. The WAP (Wireless Access Protocol) protocol addresses these issues in many ways. By working with a remote server (accessed by wireless communication), a request for some information may be made using its index lookup process. For example, contact information for the Congressman of a state might be requested. To choose a state, a group of three letters such as ‘MNO’ is selected. The result is sent to the server which responds with the name of several states in that grouping including ‘Nebraska, Nevada, New Hampshire and others. Then the server will obtain the required information and send it to the handheld. Another function that WAP enables is the download of graphic images. For instance, a user requests a stock history for the last hour of activity. The server will prepare a graphic and download it to the handheld-without requiring a graphing program on the handheld. These are but two examples of the ways that WAP allows software developers for handhelds to enhance functionality.

However, there are several limitations to WAP. The index lookup process requires several transactions. Each request can take from a few seconds to a minute depending on connectivity and server availability. The process for displaying graphics also has drawbacks. A chart may require a data range and then download an image. If it is desired to view the same chart with a slightly different range, then the entire screen contents need to be reloaded. This is can result in sluggish performance.

If instructions to the handheld to identify a state while keying in letters or to regenerate a graph as new data comes in using a simple computing engine that reads those instructions in the form of a data file, then the disadvantages of WAP could be circumvented.

The alternative to WAP, until now, has been to download a dedicated program for each area of functionality. Such a program, typically written in Java or BREW, would consume a share of the handheld program space. Although applications can sometimes be loaded over the air, the size of these programs and the limited bandwidth to constantly reload them makes it impractical to load and unload (as is done with a desktop computer from a hard disk). These are but few of the problems that are addressed by the inventive method described within.

What is needed is a method to make a broad variety of programs available to the user while requiring a small memory footprint, an efficient communication strategy and flexible loading and unloading. A system to customize, deliver and charge for the use of the programs would provide the necessary infrastructure to make this method work. The invention herein described realizes this solution.

The use of mark up languages such as the subsets of SGML (HTML and XML) has facilitated the development of communication across computing platforms. The mark up language, being in text format, can be read by most any communication device and interpreted according to its operating system. Web browsers are a form of data driven engines that read files in HTML and perform various functions Protocols for transport have also seen a lot of development. One promising protocol is SOAP (Simple Object Access Protocol). It provides a means for sending a request to a SOAP server that can result in a response with the requested information.

Billing for services, such as that of phone service has undergone extensive change in the last several years. Billing for use of a landline was done by measuring direct use. Billing for payphones was done by placing coins or passing a credit card in the phone. However, recent changes in billing accommodate an advance payment in exchange for a code that enables service. A revolutionary new approach to billing is enabled as a process of the invention.

Accordingly, a need remains for improved data driven engines and software systems foruse with handheld devices and other remote communication devices.

### DISCLOSURE OF INVENTION

Accordingly, it is an object of the present invention to provide a means to deliver programmability to a handheld without having to download a new program for each type of functionality.

Another object of the invention is to provide a system which initializes itself without requiring the intervention of the user or server administrator.

Yet another object of the invention is to provide a means to administer the provision of Personalitym Agents and PersonalityTM credits to the handhelds.

A further object of the present invention is to provide a data driven entry and query interface through wireless handheld devices (such as high end cellular telephones) wireless PDAs other compact handheld devices.

An additional object of the present invention is to provide a control or menu based entry system which is easy to use, minimizes download time and handheld system resource usage.

Briefly, one preferred embodiment of the present invention is data driven engine and system and method for using such in connection with handheld devices used in wireless communication.

The presently preferred embodiment is implemented by Itrezzo, Inc. of Campbell, California under the PERSONALITY™ trademark. Various components of the system are referred to herein in terms of the language used by Itrezzo, Inc. and components will be entitled “Personality™ ______”. The trademark symbol, however, is omitted from this point forward in the interest of simplicity.

The preferred embodiment of the present invention provides a method for running applications on a handheld either from the handheld itself or from a remote server. The method is unique in that one level of abstraction from the device itself is achieved with a data driven engine, (referred to as an APE). The APE has the functionalities of: parsing markup text; and launching a process whereby registration with a server is performed, resulting in a homepage with available applications displayed making function calls to the device to perform actions such as display, access device information, send and receive objects. Since the APE interprets documents for the device, the documents can be device independent.

The group of files read by the device are referred to as a Personality™ Agent. These agents are written in a markup language (in this case XML) and consist of the following files:
an application document which is an omnibus document holding the list of supporting documents;
a definitions document which holds the data definitions (DataItems) and other miscellaneous definitions;
a screens document which defines all of the “screens” that a particular Personality™ Agent component uses, optionally defining menus, a screen-level list (such as Airport Weather uses) and forms consisting of edit controls, static text, choice controls, etc. menus link screen selections or data entry with transport actions or screen navigation;
an actions document (optional) which defines executable objects actions such as software functions that can be referenced by name (soft-coded) and called upon to execute. Actions include logical constructs that operate on DataItems or known entities such as Transport results. Examples of Actions are ExitApp, CloseScreen, NextScreen, LaunchPersonality, SOAPTransport and ShowError;
a transport document (optional) which defines all of the transport methods used by the Personality™ Agent component (for the J2ME platform this is currently a SOAP, XML or email type transport method);
a styles document (optional) which defines the fonts, font attributes, positioning, tab order, color, graphics, etc shown on the display and
one or more data documents (optional) which may include additional supporting data documents such as for populating lists and forms including files which may be customized for specific users.

The uniqueness in these Personality™ Agents is that they are structured by functionality. The APE “knows” which documents need to be read after reading the Application Document. The User interface is handled by a single document and communications is handled by another document.

The third element of the present invention is a system administrator called the itrezzo™ Agent Administrator. The Administrator operates from the server and provides for the administration of user settings. It controls access to Personality™ Agents, tracks credits and manages the home page for each user. Some of the functions performed are:
provisioning itrezzo™ Agent users, (may optionally be done automatically during device registration);
additions, deletions and backup of Personality Agent components;
Personality Agent component assignment to Users wherein the administrator can configure access to Personality Agent components for Users and groups of Users.

The itrezzoAgent Administrator is unique in that it essentially determines the extent of functionality available to the handheld, provisions the handheld with that functionality and monitors the use of that functionality in a manner that facilitates enterprise management and provides users exactly what they need.

Another important component of the present invention is the concept of Personality™ Credits. This is a unique concept whereby functionality and use of a handheld is measured in a way that can be billed. The functionality is provided by Agents. Credits are consumed by installation, use and duration that a Personality Agent is installed. The uniqueness of Personality Credits is that the usage of a handheld is metered by a remote entity (in this case a System Administrator on a server).

An advantage of the present invention is that the system is efficient in that programmability is enabled by transmitting a set of text files (a Personality™ Agent).

Still another advantage of the present invention is that the user may select which Personality™ Agents to run. If the Personality™ Agent is not on the handheld but has been provisioned, it will be downloaded automatically.

A further advantage of the present invention is that only one software program (the APE) needs to be downloaded directly from a computer.

Yet another advantage of the present invention is that it permits the administrator to determine which Personality™ Agents are available, push them on to the handheld and meter their usage.

An additional advantage is that the present invention has the ability to associate credits which are billable to the usage of Personality™ Agents.

Still another advantage of the present invention is that centralized online storage of data and program components avoids potential overloading of local storage capacities.

Yet another advantage of the present system is that it allows companies to tailor the Personality™ Agents to suit their specific needs without extensive programming to deliver new wireless capabilities to the users over the air.

These and other objects and advantages of the present invention will become clear to those skilled in the art in view of the description of the best presently known modes of carrying out the invention and the industrial applicability of the preferred embodiments as described herein and as illustrated in the several figures of the drawings.

### BRIEF DESCRIPTION OF THE DRAWINGS

The purposes and advantages of the present invention will be apparent from the following detailed description in conjunction with the appended drawings in which:

FIG. 1 is a stylized schematic view of a hand held unit and a pair of servers, illustrating the communications scheme for operation of the system;

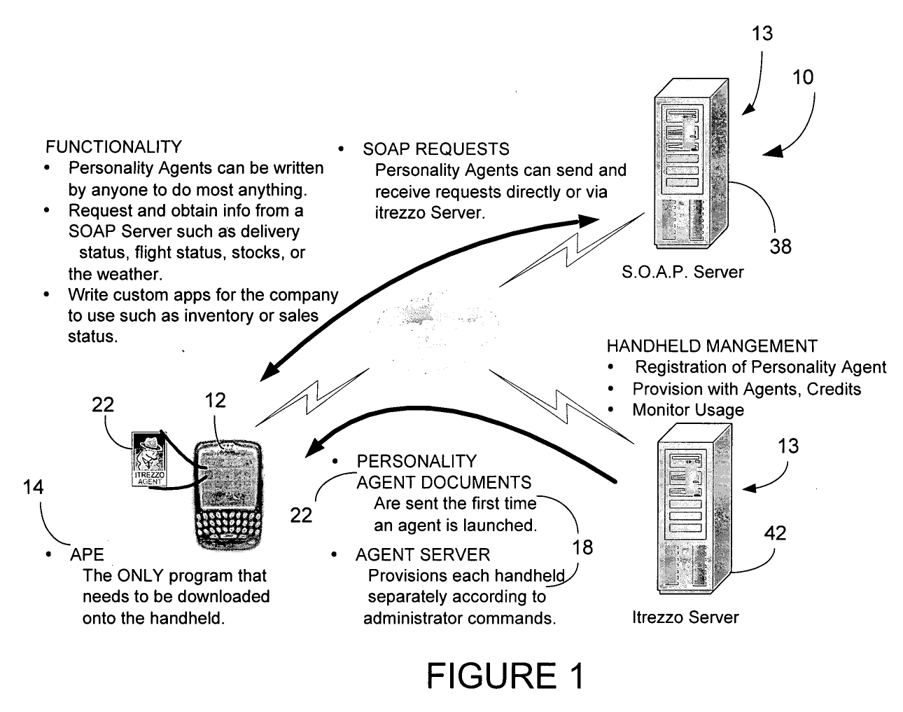

FIG. 2 is a schematic illustrating over the air delivery of applications;

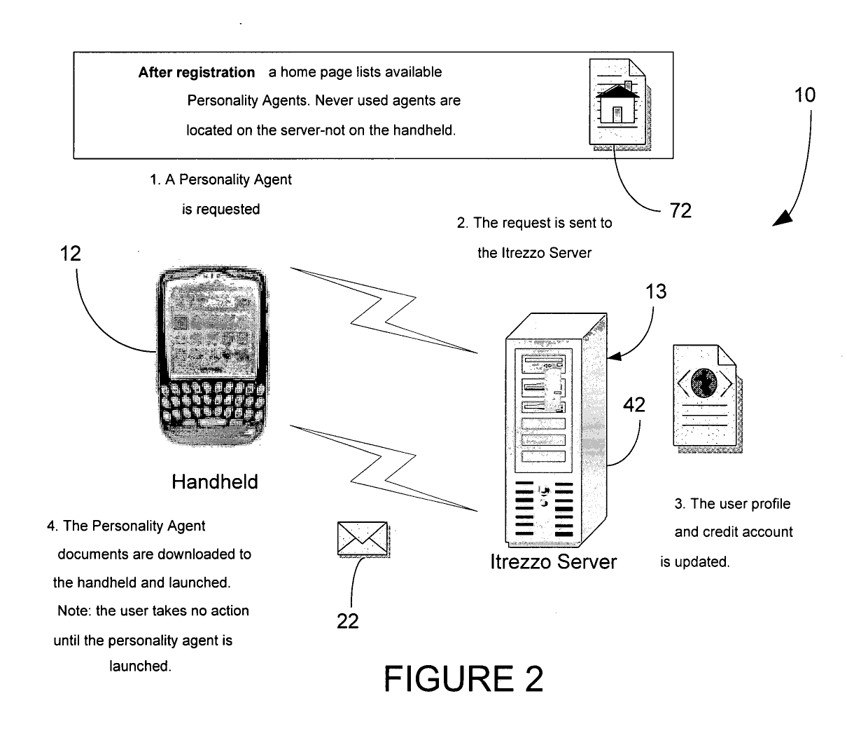

FIG. 3 is a schematic diagram of the process for searching by using predefined search paths on a remote server;

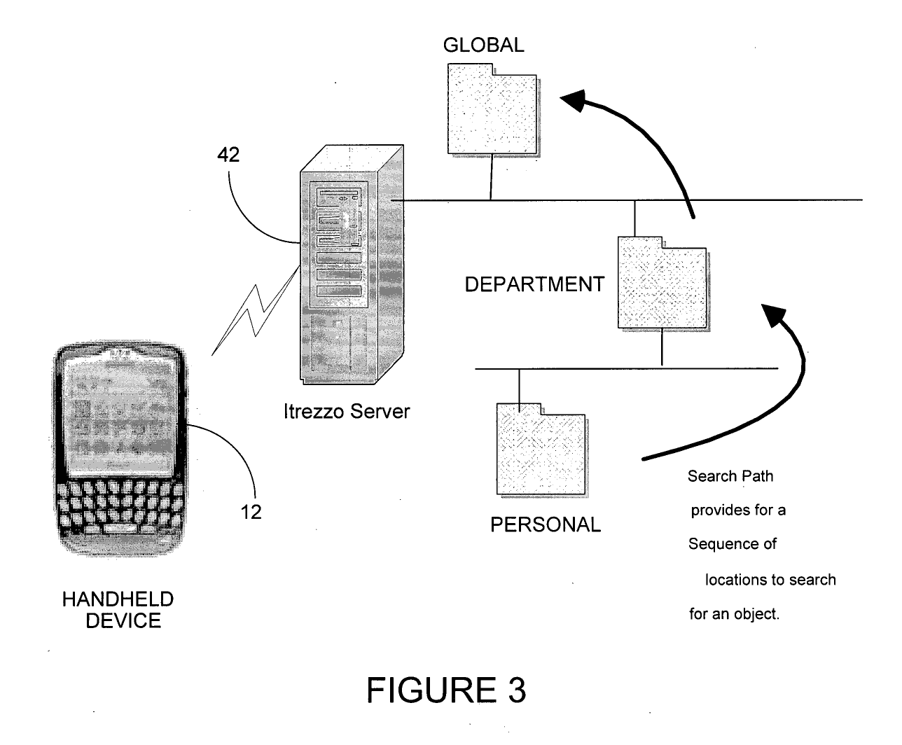

FIG. 4 is a schematic diagram illustrating a series of typical program components (Personality™ Agents) for use on a handheld device;

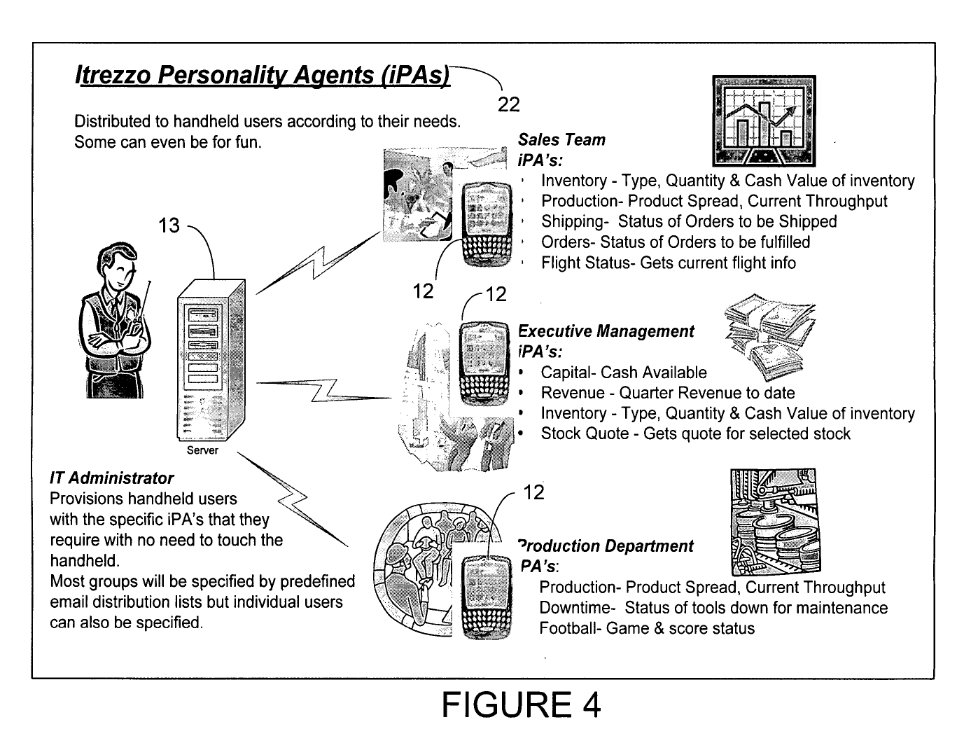

FIG. 5 is a schematic diagram illustrating the content of a typical Personality™ Agent and what the APE can do with it on a handheld;

FIG. 6 is a schematic diagram illustrating a typical registration process;

FIG. 7 is a schematic diagram illustrating the operation of the Personality™ Credits feature of the invention; and

FIG. 8 is a flow chart diagram illustrating the process flow of a Personality™ Agent between the handheld and the server.

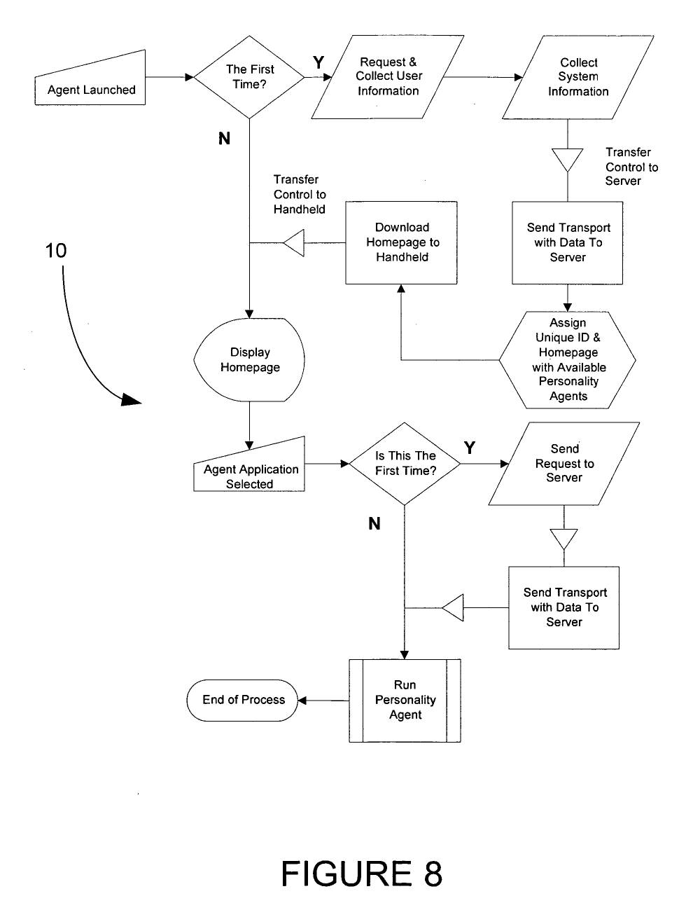

### BEST MODE FOR CARRYING OUT THE INVENTION

The present invention is a system 10 which involves facilitation of a unique method for performing activities on a handheld device 12 adapted for wireless communication with one or more remote servers 13. This method includes implementing an inventive base multi-purpose data driven engine 14 programmed on the device 12 and a unique format 16 for documents 18 written in a markup language 20 that drive it. The data driven engine 14 is a resident program on the handheld 12 that parses text and results in the display of user screens and menus in accordance to the text documents 18 upon which it is acting. In the Preferred Embodiment this is called the Agent Personality Engine (APE) 12. The uniqueness is that instead of writing a program for each area of functionality, a single program can read a small group of document files 22 (each group is referred to by the inventors as a Personality™ Agent 22) each of which, when read by the data driven engine 14, provides the functionality of a program. Each Personality Agent (PA) 22 consists of a set of documents 18 defining the Application 23 Screens 24, Menus 26, Transports (SOAP definitions) 28, Styles 92, Data Types 30, Event Handlers 32 and predefined Actions 34. Thus, instead of the effort and memory expense of downloading a program, a Personality Agent 22 is read by the data driven engine 14. Most Personality Agents 22 are activated by accessing a control 36 from the handheld device 12

The data driven engine 14 is adapted to run applications on the handheld device 12, such as a BlackBerry™ wireless PDA. The data that drives the engine is in the unique document format (itrezzo Personality™ Agent) written in a markup language 20 and may originate from the device 12 itself or be received from a remote server 38. The applications may be local to the handheld 12 or situated on remote server 13 such as a remote computing device 38, a SOAP server or the like.

In the preferred embodiment 10 illustrated in the several figures of the drawings, the data driven engine 14 is designated as the Itrezzo™ Agent Personality Engine (APE) 14 and will be fully programmable via “Over the Air” delivery of a variety of applications packaged as itrezzo Personality™ Agent components 22. Personality™ Agent components 22 can be added, deleted and upgraded without the need for a software modification. However, the application engine 12 will independently require software upgrades to improve functionality and to fix bugs.

The initial platform for Itrezzo Personality Agent components 22 is the RIM BlackBerry Java platform, selected because of the MDS capability. The “Over the Air” programmability of the itrezzo Agent is based on a data-driven model. Using an XML dialect defined as the markup language 20, an XML document 18 is accessed over the air by the itrezzoAgent 22 on the handheld 12 that defines the application functionality. The APE 14 is an itrezzoAgent client and has no specific user application functionality of its own. The XML documents 18 that drive the APE 14 contain definitions for menus 26, screens 24, screen fields (controls) 36, actions 34, styles 92, and command handling definitions for interacting with servers 38.

SOAP (Simple Object Access Protocol) is a critical technology utilized by this architecture. SOAP, being an XML dialect itself, allows the APE architecture to data-drive Remote Procedure Calls (RPC). The APE 14 then provides the GUI (Graphic User Interface) and data validation and also using the server 38 for additional business logic processing of data.

An important aspect of the operation of the system 10 is the startup process of homing and bootstrapping 40. The APE 14 must register itself with the server 38 before Personality Agents 22 can be loaded into the device 12. A specific server 38 identified as an itrezzoAgent server 42 populates the Asset Management 44 repository (database) with the registration information 46. Homing is the process or scheme for getting the APE 14 to know how to locate the server 42. While the APE 14 is a data-driven application engine, it needs to be primed with the initial data 48 to get it started. This is called the bootstrap. The APE 14 hard-codes a SOAP web-service at a predefined URI (such as itrezzoagent.com) to accomplish homing and bootstrapping. One aspect of the bootstrap involves passing the name of the initial Personality Agent 22 to be loaded, typically identified as User Registration 50, to the APE as this is not hard-coded. Thereafter, all processing following the bootstrap on the handheld 12 is performed using the Personality Agent components 22. An administrator can create an internal DNS definition for the predefined URI that could specify the IP address of their internal itrezzoAgent user home page.

Another important aspect of the system is identified as a Personality Broker 52. The itrezzo Personality Broker (iPB) 52 consists of a component on the server that allows for user profile creation, Personality Agent importing, Personality Agent storage, user management, and access by web-services that supply Personality Agents 22 to the handhelds 12. The Personality Broker 52 function is managed and configured with an enhancement to the existing itrezzo Agent Administration application for performing Personality Agent 22 import and user management. An administrator uses this application to perform the following tasks:
provisioning itrezzoAgent users, (may optionally be done automatically during device registration);
defining user groups that receive a certain set of Personality Agents 22, credits 82 and permissions;
providing additions, deletions and backup of Personality Agents; and
assigning specific Personality Agent components 22 to specific Users, such as when an administrator configures access to selected

Personality Agent components 22 for Users and Groups of users. Another important aspect of the system 10 is to provide for the importation 54 of Personality Agents 22. Importing a new Personality Agent 22 into the iPB 52 involves the following:
delivering a Personality Agent Package 56 in the form of a compressed library file 58 contains the Personality Agent component xml files and the manifest document;
opening this library file 58 by the iPB 52 to get the manifest document during which the iPB 52 constructs the container hierarchy based on the URNs found in the profile and loads the xml files into the respective containers;
automatically creating a Personality Alias 60 for each document 18 wherein the “SuggestedAlias” in the profile document 18 is used if it is unique to the system, or if not, the Personality Alias 60 is modified according to some algorithm that attempts to preserve as much of the character in the suggested alias as possible;
mapping the Personality Aliases 60 to Fully Qualified Name 62 (FQN: URN+filename) is maintained as well as a mapping of Alias and Personality Profile with the AliasDataItem values being stored in the associated “Definitions” file;
creating a Personality Agent “Application” document 64 which is derived from the Personality manifest document;
assigning a “Cost” attribute 66 to the Personality Agent which value is propagated to the Application document when it is created; and
adding a “Serial Number” attribute 68 to each Personality Agent Document Root Element for first time imports, with subsequent imports reflecting an incremented serial number.

The data driven engine 14 controls inbound and outbound queuing. The APE 14 will queue up outbound transports when there is an interruption in communication.

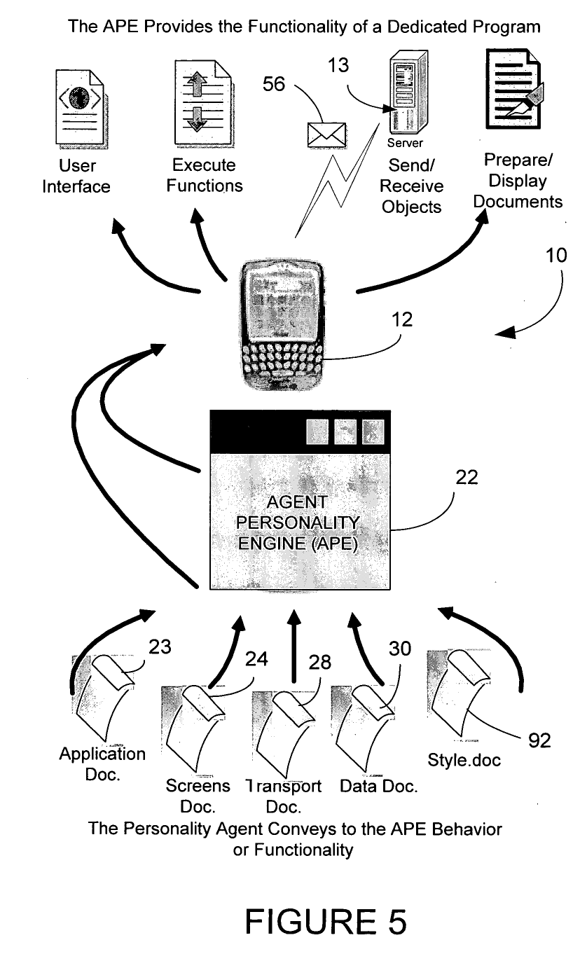

The markup format for writing a group of text files 22 in the markup language 20 is illustrated in FIG. 5 as the Personality Agent 22. Each Personality Agent 22 consists of a set of documents defining the Screens 24, Menus 16, Transports 28, Data Types 30, Event Handlers 32 and predefined Actions 34. It is the Personality Agent 22 that provides the characteristics to the activity of the data driven engine 14 and not the engine itself.

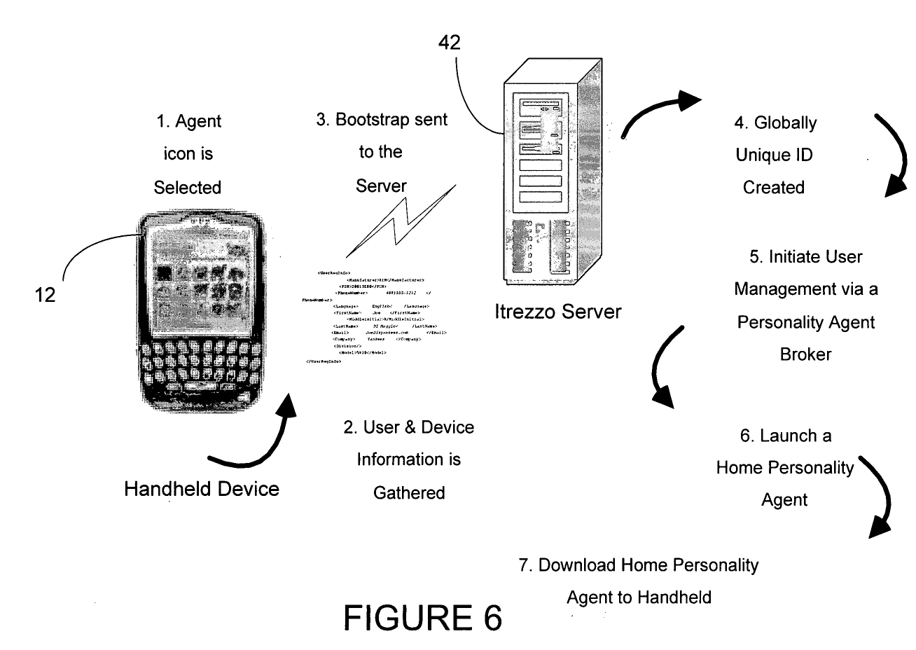

As discussed above, one of the principal Personality Agent components 22 is the Bootstrapping Personality Agent 70 which is a Personality Agent selected for the function of initializing the activity of this system 10. The handheld device 12 creates a home page 72 which will conform to the user according to the Personality Agent components 22 they use and the configuration of the system by an administrator. The action of registration is illustrated in FIG. 6.

One function of the system involved the uploading of personalization documents. The first time that the APE 14 is activated a default bootstrap Personality Agent 72 is run. This bootstrap agent 72 queries the handheld 12 for user information such as PIN (Personal Identification Number), SMTP address, etc and uploads it to the server 38.

Another function of Personality Agents 22 is to launch one or more Personality Agents. These may be launched when the agent that performs the launching is started, while it is running or when it closes.

Sometimes it is desirable to facilitate automatic loading and caching of Personality Agents 22. This is the function of organization and administration of Personality Agents 22 on a handheld 12 and listing them on the user's home page 72. The particular Personality Agent 22 is automatically downloaded and saved on the handheld 12 only if a request is made to use it. Memory on the handheld 12 is saved resulting in a larger total available memory work space

Another feature of the system 10 is a DataItem Manager 74. This feature solves the problem presented by the soft-coded or data-driven nature of the APE. For example, DataItems 18 act as a intermediary data repository facilitating activity between loosely coupled GUI and Transport components. “DataItems” and the DataItem Manager 74 facilitate the coordination of activity in the APE 14. The DataItem/DataItem Manager 74 include a notification mechanism that allow APE components, such as Screens 24, to track changes to specific data items and Perform a set of actions 34 on that occurrence, all being data-driven.

These data items 18 are published to a lookup table that is read by the APE 14 each time a Personality Agent 22 is run. When a Personality Agent 22 is run the first time, it will publish to this table the data items that, when their event occurs, will cause this particular Personality Agent 22 to wake up or resume with a notification that the data item has changed.

These data items 18 are published to a lookup table that is read by the APE 14 each time a Personality Agent 22 is run. When a Personality Agent is run the first time, it will publish specific data items to this table. When the event for those specific data items occurs, this particular Personality Agent is caused to wake up or resume with a notification that the data item has changed.

A style sheet 76 indicates to the APE the display style (such as font, size, bold and italic, positioning on screen and tab order) that is to be used in the user interface. This differs from the DTD used by XML for displaying documents in HTML since the handheld display is not in HTML.

Various additional specific Personality Agents are provided to: display memory; radio; network; access any web service; explore a mailbox; provide user registration; play audio; initiate timer events; and manages updates. The system 10 may also utilize a set of system administration functions 78 and tools 80. These provide server side management and control for administering the use and nature of Personality Agents 22 used on the handhelds 12. These applications provides a user interface to enable an administrator to manage the agents available to a user.

One of the tools 80 maintains and saves the home page 72 for each user via the registration process. User information is stored that in a way that tailors the way the server 38 interacts with the handheld 12. For instance, the type of handheld 12 might determine the version of Personality Agent 22 that is downloaded. The language chosen for the device menu will determine which user interface is utilized. Another type of tool 80 will maintain a library of available Personality Agents 22 that would be available to handheld users. Each of these will only be downloaded when requested the first time.

Another tool 80 provides multilingual support. In some cases, the server 38 will have a language preference for the user. This will then direct which language the user interface should have by substituting different screen documents which are the only documents that have text for display.

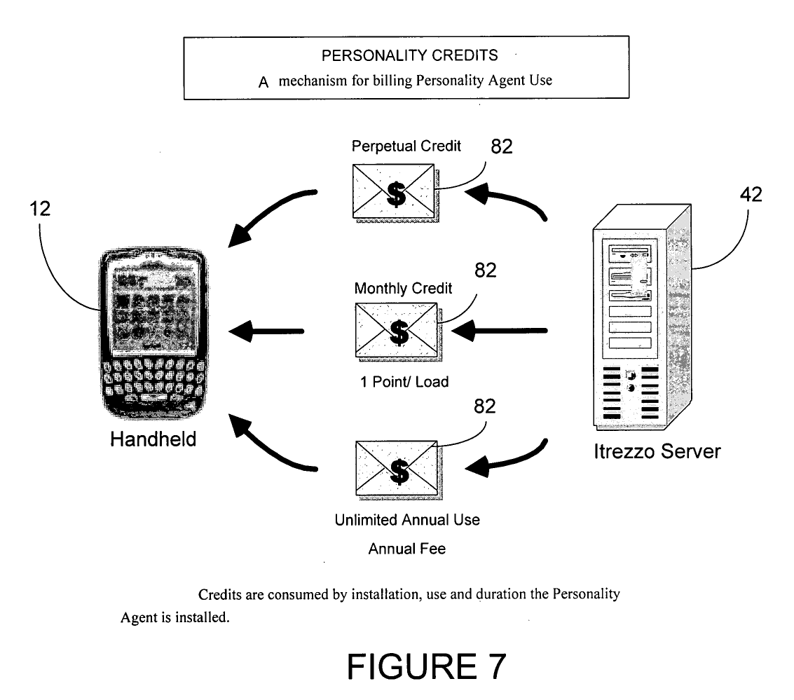

The illustration of FIG. 7 shows the utilization of the Personality Credits 82. This server application 78 provides a mechanism for billing for the usage of Personality Agents 22. Credits are consumed by installation, use and duration it is installed. Examples of the preferred implementation are: Perpetual Credit; Monthly; Static; and Unlimited. Sometimes it is desired to provide modifications to a previously installed Personality Agent. This is the means by which the server application 78 can add or remove functionality to the handheld by adding or removing Personality Agents and downloading modified versions of previously existing ones.

Administration functions 78 also can push a Personality Agent which will allow it to perform functions that are not presently enabled on the handheld. Further administration functions 78 can import Personality Agent and web service and assign these to users on a mandatory or optional basis and provide shared itrezzo™ Personality™ Agent documents.

Another system function provides Grid Layout 84 which is a user interface to enable the filling out of a form with entry fields on a handheld device 12 with a limited viewing window and resolution. A zoom feature 86 enables part or all of the screen to zoom in on one or more cells. In the case of partial zoom, one portion of the screen will display a low resolution image of the sheet and another will show a high resolution image. The Grid Layout function creates a set of controls 36 at the bottom of the screen. These controls 36 might correspond to thumb keys at the top of a thumb pad on some handhelds. Those controls 36 enable scrolling horizontally and vertically so as to access any part of the grid sheet. The Grid Layout 86 can be defined and integrated from XML, so it may be mapped to a SOAP array for efficient operation and use.

Another function is a SOAP Proxy 88 which is a method to bypass the relatively narrow bandwidth limitations of sending and receiving SOAP transports from a handheld 12. For a given SOAP service, the SOAP library will have been made available to the handheld. To make a SOAP request, the library objects are used to formulate a request without a transport envelope. The encrypted and compressed request is sent to the itrezzoAgent server 42 which encapsulates the request into a SOAP envelope, encrypts it and sends it to the SOAP server. This is much faster than for the handheld to send the SOAP envelope directly to the SOAP Server. Receipt of SOAP transports is the same. A SOAP envelope is received by the itrezzoAgent Server 42, decrypted, repackaged and delivered to the SOAP consumer.

The inventive system 10 provides dual input controls with persistence- a method to perform a selection from a large set of objects. It is optimized for a handheld keyboard and pointing device. A search for an object with a one to one (or many to one) correspondence to another is facilitated with dual controls. For instance, an airport code has this correspondence with a city. Thus one would enter letters of the city into one control until the city appeared. In the second control, the airport code would appear. In the case: that there is more than one airport in a given city, then the first control would have a scroll control to enable a choice.

Among the processes provided in the system 10 is the Homing and Registration process 40. This is ability of the APE 14 to be run without any prior setup and is a process where the handheld user activates the Personality Agent 22 which then requests and sends registration information to the server application. The server, in turn stores the information, prepares and sends a home page to the handheld. Significantly, no prior setup is required on the handheld or the server.

Another process is itrezzo™ Agent Server Push Notification 90. The administrator preconfigured the user and device profile to recognize handheld activation on the wireless server. It could then send a push notification 90 to the handheld 12 with the URI of the desired handheld. The resident itrezzoAgent applet will be automatically set to the desired home page 72 and that home page could even be activated and brought to the foreground in the user's handheld 12. If permitted, a Wireless Server policy can be added that would force the itrezzoAgent applet home page to the specified policy.

Another function is to define search paths on the server by the administrator for the handheld. This is the ability to define a chain of locations to search when the handheld user is seeking a document or object. This enables degrees of personalization. For instance, a default copy of a file called UserPreferences would be located in a root directory corresponding to a global company folder. A given department might modify that file for use by its department members and store it in the department sub directory. Then a user would modify the department copy for his or her own taste. The search path would direct the system administrator to begin the search in the user's folder. Then, if there is no file, to search in the department and company folders in sequence.

While various embodiments have been described above, it should be understood that they have been presented by way of example only, and not as limitation.

### Industrial Applicability

The present invention is adapted for use with handheld wireless communications devices. It is particularly intended for use by organizations with central control of a large number of handheld units. In these organizations it may be desirable for central system administration to make available sets of common applications which are available for access and utilization by selected groups of individual users.

The operation of the system 10 is illustrated in the drawings, in particular. Each of the drawings shows the operation of some aspect of the system and the drawings are substantially self explanatory.

1. A system for facilitating the operation of program functions in a wireless communications array including user devices and centralized servers, comprising:
a data driven engine situated on the user device; and
a plurality of program components located on a centralized server, available for selective download upon system calls from the user device, wherein said plurality of program components is characterized by being a series of documents in a unique format and a defined markup language.

2. The system of claim 1, wherein
said data driven engine performs the functions of parsing markup text and launching bootstrap registration processes between the user device and the server.

3. The system of claim 1, wherein
each of said plurality of program components is selected from the group including: application documents; definitions documents; screens documents; actions documents; transport documents, styles documents; and data documents.

3. The system of claim 3, wherein
at least one said application document is provided; and
said data driven engine utilizes said application document to select which other documents are needed for interface and operation of the system.

4. The system of claim 1, wherein
said user device is a handheld communication device selected from the group including: high end cellular telephones; wireless PDAs; BlackBerry™ devices and miniature portable computing devices with wireless capability.

5. The system of claim 1, wherein
said plurality of program components on the remote server includes an agent administrator component for controlling user device access to others of said plurality of program components.

6. The system of claim 5, wherein
said agent administrator further tracks credits accumulated by the operation of said user device and manages a homepage customized for use by said user device.

7. The system of claim 3, wherein
said plurality of program components on the remote server includes data items acting as an intermediary repository between graphic user interface and transport components.

8. The system of claim 7, wherein
said data items are published to a lookup table suitable for being read by said data driven engine, said lookup table providing links to specific components used in the past to facilitate waking up or resuming processes and components affiliated with the particular one of said data items.

9. The system of claim 1, wherein
said data driven engine operates with one or more of said plurality of program components to generate a grid layout user interface on the user device, said grid layout user interface facilitating filling out forms with entry fields.

10. The system of claim 9, wherein
said grid layout user interface further includes an zoom feature for facilitating display of specific cells or groups of cells on the user device.

11. The system of claim 1, and further including
a SOAP proxy function, which utilizes a library and compresses and encrypts SOAP commands from said user device to said server by said data driven engine, said library containing frequently utilized SOAP commands which may be utilized for transmission with an inefficient transport method, such that requests corresponding to said library commands may be encapsulated into a SOAP envelope, encrypted and transmitted.

12. The system of claim 1, wherein
said plurality of program components provides a method for facilitating said data driven engine to provide a user interface having dual input controls with persistence, to facilitate lookups and forms entry functions.

13. The system of claim 1, wherein
said data driven engine is provided with a homing function to facilitate initialization and registration of a particular user device with a remote server, without prior setup of either said user device or said server.

14. The system of claim 5, wherein
said agent administrator component includes an ability to define a chain of locations for searching documents or objects.

15. In a wireless communication and computing system, the improvement comprising:
providing a handheld computing device with remote communication and input capability;
providing a remote server, with wireless communication capability;
loading said handheld with an APE data driven engine; and
loading said remote server with a plurality of agent text files adapted to operate with said APE data driven engine, such that said agent text files may be selectively accessed from said handheld upon user request input.

16. The improvement of claim 15, wherein
said agent text files are written in a markup language uniquely configured for use by said APE data driven engine.

17. The improvement of claim 15, wherein
said APE data driven engine is provided with a preloaded bootstrapping agent to facilitate initialization and registration of said handheld with said remote server.

18. The improvement of claim 15, wherein
said agent text files include applications, screens, menus, transports, data types, event handlers, actions, styles and control files.

19. The improvement of claim 15, wherein
said agent text files include cost attribute and serial number attribute files for facilitating tracking of credit, usage and billing information.
